(19) United States
(12) Patent Application Publication
(10) Pub. No.: US 2010/0232858 A1
(43) Pub. Date: Sep. 16, 2010

(54) METHOD AND APPARATUS TO CONTROL PRINTER BASED ON FEEDING DIRECTION OF PAPER

(75) Inventors: Si-ho JANG, Yongin-si (KR); Jun-chul Shin, Suwo-si (KR); Cl oul-so Kim, Suwo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/627,019

(22) Filed: Nov. 30, 2009

(30) Foreign Application Priority Data
Mar. 10, 2009 (KR) 10-2009-0020358

(51) Int. Cl. B41J 11/20; B41L 1/02; B41J 11/44

(52) U.S. Cl. 400/55; 101/485; 400/76

(57) ABSTRACT

A method and a printer device capable of correctly processing a printing operation even when a user feeds particular paper, of which a front/back surface (printing surface) and a top/bottom direction (printing direction) are fixed, in a incorrect direction, by determining whether a current feeding direction of the paper is correct and rotating a printing direction by 180° before performing the printing operation if the feeding direction is incorrect.

### CROSS-REFERENCE TO RELATED APPLICATIONS

This application claims priority under 35 U.S.C. §119(a) from Korean Patent Application No. 10-2009-0020358, filed on Mar. 10, 2009, in the Korean Intellectual Property Office, the disclosure of which is incorporated herein in its entirety by reference.

### BACKGROUND

1. Field of the Invention

The present general inventive concept relates to a printer, and more particularly, to a method of efficiently processing a printing operation of a printer.

2. Description of the Related Art

Various types of paper are used in a printer and a user selects and feeds paper of appropriate size and quality into a printer based on properties of a printing operation.

A4 paper is generally used in homes and offices. In this case, a user may feed paper into a printer without considering a front/back surface (printing surface) or a top/bottom direction (printing direction) of the paper.

However, in some cases, the printing surface or the printing direction of the paper should be considered in order to print documents properly. For example, if paper having different surface qualities, such as, photo paper, of which only one surface is coated, is used, the printing surface of the paper should be considered. Also, if exclusive paper, on which a company logo is marked, is used to print a letter to be sent outside the company, the printing direction of the paper is important.

As described above, paper should be fed into a printer in consideration of a printing surface or a printing direction. However, users may experience confusion due to various paper feeding methods according to printer manufacturers or product models and paper and ink/toner may be wasted due to a repeated printing operation caused by printing operation errors.

### SUMMARY

The present general inventive concept provides a method and apparatus for controlling a printer to process a printing operation in a correct printing direction regardless of a paper feeding method of a user.

Embodiments of the present general inventive concept will be set forth in part in the description which follows and, in part, will be obvious from the description, or may be learned by practice of the present general inventive concept.

Embodiments of the present general inventive concept provide a printing method of a printer, the method including detecting a mark from a predetermined region of paper; determining a printing direction based on a result of the detecting; and processing a printing operation based on the determined printing direction.

The determined printing direction may include determining a current direction of the paper or a direction obtained by rotating the current direction of the paper by 180°, as the printing direction based on a property of the detected mark.

If no mark is detected from the predetermined region, the processing may include flipping and re-feeding the paper.

If no mark is detected from the predetermined region, the determined printing direction may include determining a direction obtained by rotating a current direction of the paper by 180°, as the printing direction.

The property of the detected mark may include at least one of a shape, a color, and a size of the mark.

Embodiments of the present general inventive concept provide a recording medium having recorded thereon and a computer program to execute the printing method.

Embodiments of the present general inventive concept provide a printer device including a detection unit to detect a mark from a predetermined region of paper; a determination unit to determine a printing direction based on a result of the detecting; and a print control unit to process a printing operation based on the determined printing direction.

The determination unit may determine a current direction of the paper or a direction obtained by rotating the current direction of the paper by 180°, as the printing direction based on a property of the detected mark.

If no mark is detected from the predetermined region, the print control unit may flip and re-feed the paper.

If no mark is detected from the predetermined region, the determination unit may determine a direction obtained by rotating a current direction of the paper by 180°, as the printing direction.

Embodiments of the present general inventive concept further provide for a control module usable with an image forming apparatus, comprising a detection unit to detect a mark from a printing medium, and a print control unit to generate a signal according to the detected mark to control a printing operation of a print unit.

Embodiments of the present general inventive concept further provide for an image forming apparatus, comprising a print unit to perform a printing operation to form an image on a printing medium, and a control module to detect a mark from a predetermined region of fed printing medium, wherein the control module comprises a detection unit to detect a mark from a printing medium, and a print control unit to generate a signal according to the detected mark to control a printing operation of the print unit.

### BRIEF DESCRIPTION OF THE DRAWINGS

These and/or other features and utilities of the present general inventive concept will become apparent and more readily appreciated from the following description of the exemplary embodiments of the present general inventive concept, taken in conjunction with the accompanying drawings, in which:

FIG. 1 is a flowchart of a printing operation processing method, according to an exemplary embodiment of the present general inventive concept;

FIG. 2 is a flowchart of a printing direction determining method according to an exemplary embodiment of the present general inventive concept;

FIG. 3 is a flowchart of a printing direction determining method according to an exemplary embodiment of the present general inventive concept;

FIG. 4A is a diagram illustrating a sheet of paper and a mark, according to an exemplary embodiment of the present general inventive concept;

FIG. 4B is a diagram illustrating a printing operation table according to an exemplary embodiment of the present general inventive concept;

FIG. 5A is a diagram illustrating a sheet of paper and marks, according to an exemplary embodiment of the present general inventive concept;

FIG. 5B is a diagram illustrating a printing operation table according to an exemplary embodiment of the present general inventive concept; and

FIG. 6 is a block diagram of a printer device according to an exemplary embodiment of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

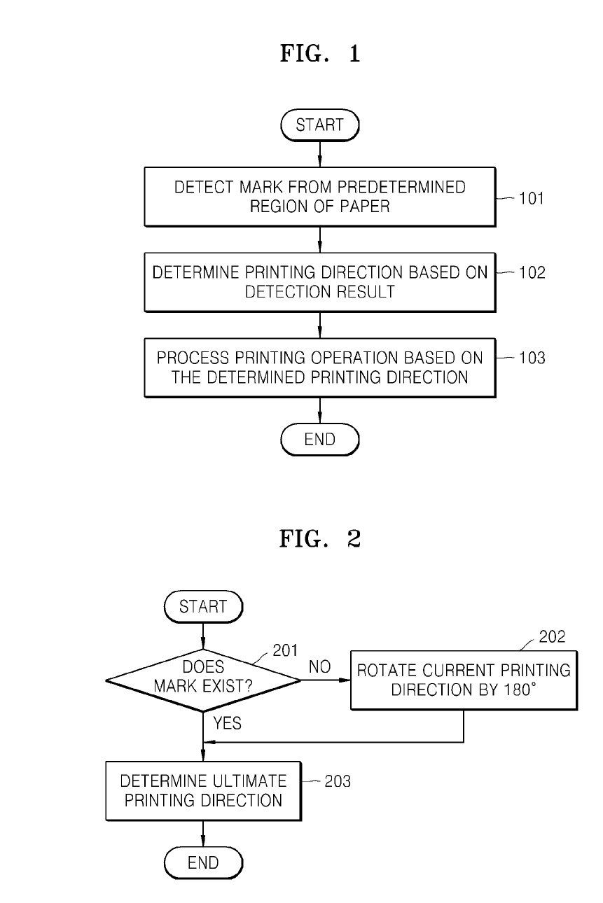

FIG. 1 is a flowchart of a printing operation processing method, according to an exemplary embodiment of the present general inventive concept.

Referring to FIG. 1, in operation 101, a printer control module usable with an image forming apparatus according to an exemplary embodiment of the present general inventive concept (hereinafter referred to as a control module) may detect a mark from a predetermined region of fed paper. Here, the mark may constitute information recorded on the paper so that the control module may determine whether the paper is fed in a correct direction. The mark may be previously printed or engraved/embossed on the paper, and may have various properties, i.e., various shapes, patterns, and colors. Also, two or more of the properties may be combined.

The mark may be formed on a printing medium, such as paper, using a print unit to print an image detectable by the control module, wherein the image is formed according to data that allows the control module to determine whether the printing medium is fed in a correct direction. The mark may be formed before or after an image is formed on the paper. The mark may be formed by an element of an image forming apparatus. An external apparatus may also form the mark on the printing medium. Additionally, it is possible that the external apparatus generates a signal to form an image on the paper. Examples of possible properties include reflective and tactile properties, bar code scan-ability, and RF micro device compatibility.

Because a region to be analyzed to sense for the mark on the paper is wide, and because the mark has various types and properties, costs and complexity of components used in the printer may increase. Thus, the smaller the region and the less types and properties the mark has, the more efficiently the printer operates.

The printer control module may have a unit to scan the paper (emit light and receive the light reflected from the paper) and to generate a signal due to the presence of the mark on the scanned paper. For example, if the mark possesses reflective properties, then the signal may be generated if a specific reflection is received from the printer control module's emitted light. Also, the printer control module may detect the mark using a unit to physically touch the paper if the mark possesses certain prescribed tactile properties. Additionally, the printer control module may use a unit to detect signals generated from the mark using either bar code or micro RF technology.

In operation 102, the control module may determine a printing direction based on a detection result.

In more detail, the control module may determine whether to process a printing operation in a direction in which the paper is currently fed or by rotating the printing direction by 180°, based on the mark detected from the paper.

In this case, the mark may be formed on the paper by using various methods. For example, if two marks having different properties are recorded in two predetermined regions for representing upper and lower portions of the paper (regions that remain relatively the same when the paper is rotated by 180°), the printer may analyze only one region so as to determine the printing direction based on the property of the mark in the region. Alternatively, the mark may be recorded in only one region of the paper and the printer may determine the printing direction by determining whether the mark exists in the region. Examples of the printing direction determining method will be described in detail later with reference to FIGS. 2, 3, 4A, and 4B.

In operation 103, the printing operation may be processed based on the printing direction determined in operation 102. For example, the printer may be controlled to perform the printing operation in the printing direction determined in operation 102 or an error message may be output via a user interface.

FIG. 2 is a flowchart of a printing direction determining method according to an exemplary embodiment of the present general inventive concept. In FIG. 2, it is assumed that a mark is recorded in only one region of paper.

Referring to FIG. 2, in operation 201, a control module may analyze a predetermined region of fed paper, i.e., a region for recording a mark, and may determine whether the mark exists.

If the mark does not exist, in operation 202, the control module may determine that a feeding direction of the paper is in the wrong direction and may rotate a printing direction by 180°. If the mark exists, the control module may determine that the feeding direction of the paper is correct and may maintain a current printing direction, and the method proceeds to operation 203.

In operation 203, an ultimate printing direction may be determined. In more detail, if the mark does not exist, a direction obtained by rotating the current printing direction by 180° may be determined as the ultimate printing direction. If the mark exists, the current printing direction is determined as the ultimate printing direction.

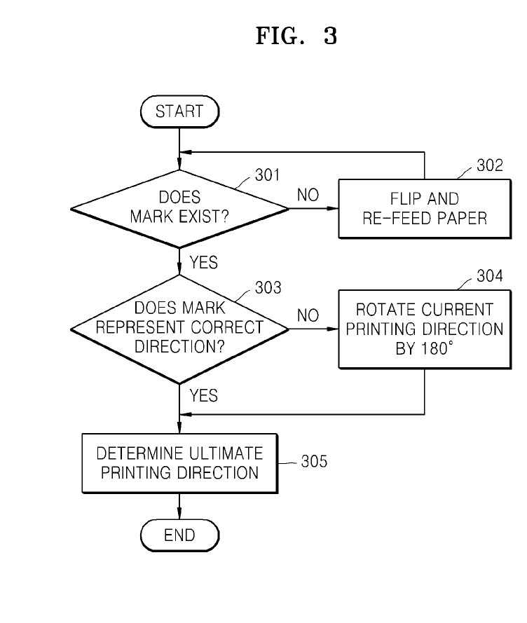

FIG. 3 is a flowchart of a printing direction determining method according to an exemplary embodiment of the present general inventive concept. In FIG. 3, two marks having different properties are recorded in two predetermined regions to represent upper and lower portions of the paper (regions that remain relatively the same when the paper is rotated by 180°).

Referring to FIG. 3, in operation 301, a control module may analyze a predetermined region of the paper and may determine whether a mark exists. Since the two regions remain relatively the same when the paper is rotated by 180°, in this case, a printer may also analyze only one region as in FIG. 2. Since different marks exist in the two regions in FIG. 3, if no mark is detected, the control module may determine that the paper is flipped over the wrong way.

Thus, if the mark does not exist, in operation 302, the control module may flip the paper and then re-feed the paper into the printer.

If the mark is detected from the paper, in operation 303, the control module may determine whether the detected mark represents a correct direction. In more detail, the control module may analyze a property of the mark and may determine whether a printing direction based on a direction in which the paper is currently fed is correct. The property may be, for example, a shape, a color, or a size.

If the detected mark represents an incorrect direction, in operation 304, a current printing direction may be rotated by 180°.

In operation 305, the control module may determine an ultimate printing direction. In more detail, if the detected mark represents a correct direction, the current printing direction may be determined as the ultimate printing direction. If the detected mark represents an incorrect direction, the current printing direction may rotate by 180°.

According to an exemplary embodiment of the present general inventive concept, if it is determined that the paper is flipped over the wrong way, the control module may flip and re-feed the paper in operation 302. However, according to an exemplary embodiment of the present general inventive concept, an error message may be output via a user interface and then the printing operation may be terminated.

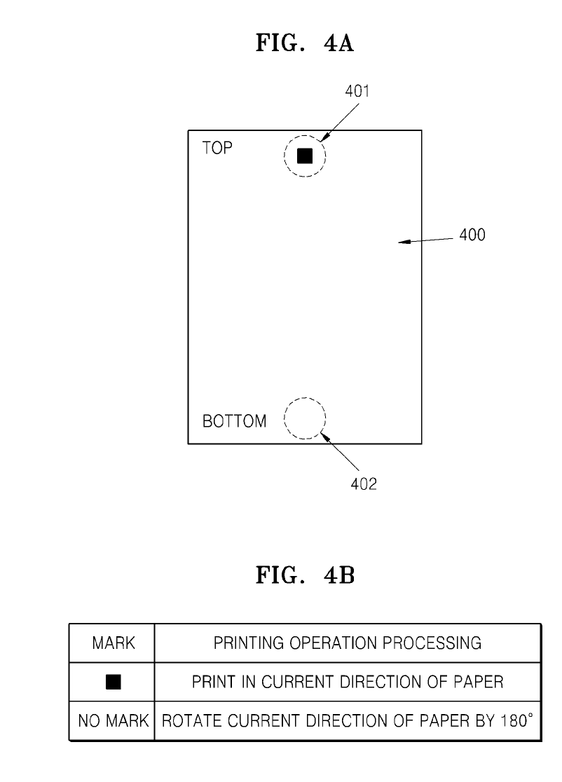

FIG. 4A is a diagram illustrating a sheet of paper and a mark, according to an exemplary of the present general inventive concept. FIG. 4B is a diagram illustrating a printing operation table according to an exemplary embodiment of the present general inventive concept. In FIGS. 4A and 4B, a mark is recorded in only one region of paper as described in relation to FIG. 2.

Referring to FIG. 4A, a mark is recorded in only an upper region 401 of a printing surface 400. A control module has the printing operation table illustrated in FIG. 4B in advance and may process a printing operation based on whether the mark is detected from the sheet of paper. In more detail, if the mark is detected, the control module may control a printer to perform the printing operation in a direction in which the sheet of paper is currently fed. The lower/opposite region 402 of the printing surface 400 may be without a mark.

If the paper is in the wrong direction, the control module may analyze an opposite region illustrated in FIG. 4A and detect no mark. In this case, the control module may determine that the sheet of paper is in the wrong direction and may determine a direction obtained by rotating a current direction of the sheet of paper by 180° as an ultimate printing direction.

According to an exemplary embodiment of the present general inventive concept, only one mark may exist and thus complexity of the control module and the printer is low.

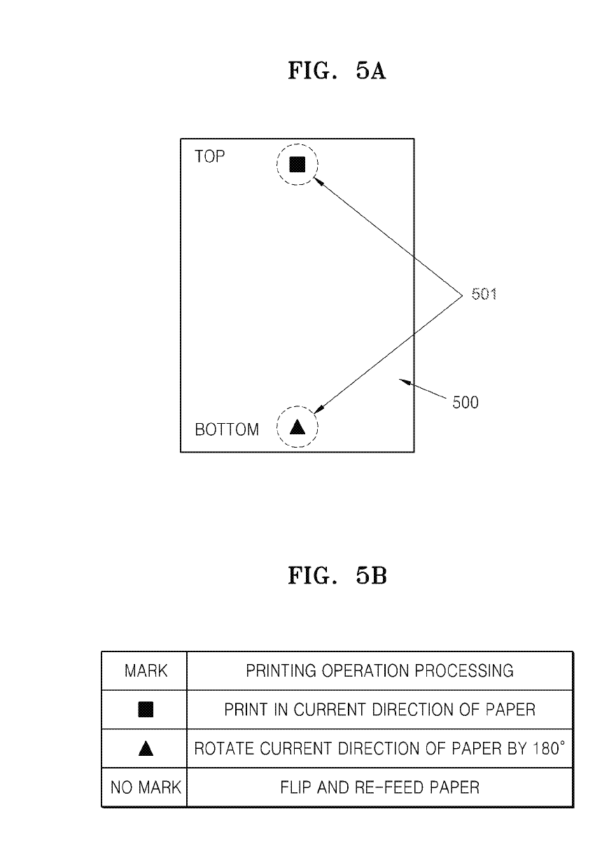

FIG. 5A is a diagram illustrating a sheet of paper and marks, according to an exemplary embodiment of the present general inventive concept. FIG. 5B is a diagram illustrating a printing operation table according to an exemplary embodiment of the present general inventive concept. In FIGS. 5A and 5B, two marks having different properties may be recorded in two regions 501 for representing upper and lower portions of a sheet of paper (regions that remain relatively the same when the sheet of paper is rotated by 180°) as in FIG. 3.

Referring to FIG. 5A, a square mark is recorded in an upper portion of a printing surface and a triangle mark is recorded in a lower portion of the printing surface 500.

Referring to FIG. 5B, if the square mark is detected, a control module may control a printer to perform a printing operation in a current direction of the paper.

However, if the triangle mark is detected, the control module may determine that the paper is in the wrong direction may determine a direction obtained by rotating the current direction of the paper by 180° as an ultimate printing direction.

Meanwhile, since the two regions remain relatively the same when the paper is rotated by 180° as described above, at least one of the marks should be detected if the sheet of paper is not flipped over the wrong way. Thus, if no mark is detected, the control module may determine that the paper is flipped over the wrong way.

According to an exemplary embodiment of the present general inventive concept, the control module may identify a case when the paper is flipped over the wrong way as well as a case when the paper is in the wrong direction.

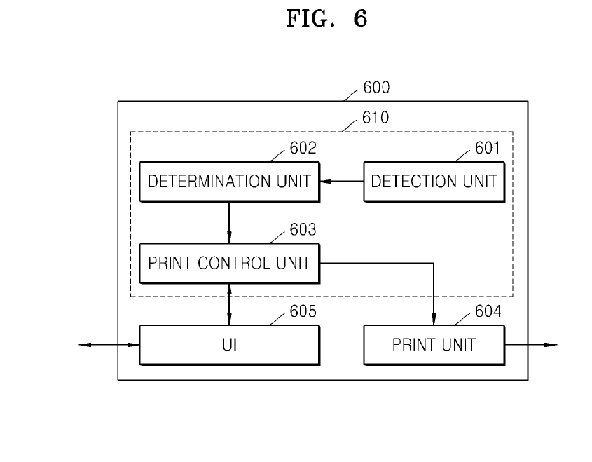

FIG. 6 is a block diagram of a printer device 600 according to an exemplary embodiment of the present general inventive concept. Although a control module is implemented as hardware in FIG. 6, it will understood by one of ordinary skill in the art that the control module may also be implemented as software.

Referring to FIG. 6, the printer device 600 may include a control module 610, a user interface 605, and a print unit 604, wherein the control module 610 may include a detection unit 601, a determination unit 602, and a print control unit 603.

The detection unit 601 may detect a mark from a predetermined region of paper.

The determination unit 602 may determine a printing direction based on a detection result.

For example, when paper is used on which two marks having different properties are recorded in two regions, the determination unit 602 may determine a current direction of the paper or a direction obtained by rotating the current direction of the paper by 180°, as an ultimate printing direction based on a property of a detected mark.

Alternatively, when paper on which a mark is recorded in only one region is used, the determination unit 602 may determine the current direction of the paper as the ultimate printing direction if a mark is detected, and may determine the direction obtained by rotating the current direction of the paper by 180°, as the ultimate printing direction if no mark is detected.

The print control unit 603 may process a printing operation based on a determination result of the determination unit 602. In more detail, the print control unit 603 may control the print unit 604 for outputting documents, to perform the printing operation based on the ultimate printing direction determined by the determination unit 602. Although paper on which two marks having different properties are recorded in two regions is used, if no mark is detected, the print control unit 603 may flip and re-feed the paper. According to an exemplary embodiment of the present general inventive concept, instead of flipping and re-feeding the paper, the print control unit 603 may output an error message via a user interface 605 and may terminate the printing operation.

All of various types of paper (i.e., the above described two types of paper) may be processed in one printer and, in this case, a user may input information regarding currently fed paper via the user interface 605.

Meanwhile, exemplary embodiments of the present general inventive concept can be written as computer programs and can be implemented in general-use digital computers that execute the programs using a computer readable recording medium. For example, the present general inventive concept may be stored in an external computer readable recording medium and downloaded into a general-use digital computer, thus allowing for easy portability of Applicant's present general inventive concept. Further, the marked print medium may be recognizable to the stored computer program, thus portability of an external computer readable recording medium with Applicants' present general inventive concept may be matched with the proper marked print medium. Further, the computer program can be written in a variety of programming languages, such as Visual Basic, C++, Delphi, Fortran, and Java.

Examples of the computer readable recording medium include magnetic storage media (e.g., ROM, floppy disks, hard disks, etc.), optical recording media (e.g., CD-ROMs, or DVDs), etc.

While the present general inventive concept has been particularly illustrated and described with reference to exemplary embodiments thereof, it will be understood by one of ordinary skill in the art that various changes in form and details may be made therein without departing from the spirit and scope of the general inventive concept invention as defined by the following claims. The exemplary embodiments should be considered in a descriptive sense only and not for purposes of limitation. Therefore, the scope of the general inventive concept is defined not by the detailed description of the invention but by the following claims, and all differences within the scope will be construed as being included in the present general inventive concept.

1. A printing method of a printer, the method comprising:
detecting a mark from a predetermined region of paper;
determining a printing direction based on a result of the detecting; and
processing a printing operation based on the determined printing direction.

2. The method of claim 1, wherein the determining a printing direction comprises:
determining a current direction of the paper or a direction obtained by rotating the current direction of the paper by 180°, as the printing direction based on a property of the detected mark.

3. The method of claim 1, wherein, if no mark is detected from the predetermined region, the processing a printing operation comprises:
flipping and re-feeding the paper.

4. The method of claim 1, wherein, if no mark is detected from the predetermined region, the determining a printing direction comprises:
determining a direction obtained by rotating a current direction of the paper by 180°, as the printing direction.

5. The method of claim 2, wherein the property of the detected mark comprises:
at least one of a shape, a color, and a size of the mark.

6. A printer device, comprising:
a detection unit to detect a mark from a predetermined region of paper;
a determination unit to determine a printing direction based on the detecting result from the detection unit; and
a print control unit to process a printing operation based on the determined printing direction.

7. The device of claim 6, wherein the determination unit determines a current direction of the paper or a direction obtained by rotating the current direction of the paper by 180°, as the printing direction based on a property of the detected mark.

8. The device of claim 6, wherein, if no mark is detected from the predetermined region, the print control unit flips and re-feeds the paper.

9. The device of claim 6, wherein, if no mark is detected from the predetermined region, the determination unit determines a direction obtained by rotating a current direction of the paper by 180°, as the printing direction.

10. The device of claim 7, wherein the property of the detected mark comprises:
at least one of a shape, a color, and a size of the mark.

11. A recording medium having recorded thereon a computer program for executing the method of claim 1.

12. A control module usable with an image forming apparatus, comprising:
a detection unit to detect a mark from a printing medium; and
a print control unit to generate a signal according to the detected mark to control a printing operation of a print unit.

13. The control module of claim 12, further comprising:
a determination unit to determine whether the paper is fed in a proper direction based upon detection by the detection unit.

14. The control module of claim 12, wherein the detection unit detects the multiple marks having different properties and the marks comprise multiple marks formed on multiple locations of the printing medium.

15. The control module of claim 12, wherein the printing operation comprises:
flipping and re-feeding the printing medium if no mark is detected.

16. The control module of claim 12, wherein the printing operation comprises a feeding direction and the print control unit controls the feeding directions of the printing medium of the print unit.

17. An image forming apparatus, comprising:
a print unit to perform a printing operation to form an image on a printing medium; and
a control module to detect a mark from a predetermined region of fed printing medium; wherein the control module comprises:
a detection unit to detect a mark from a printing medium; and
a print control unit to generate a signal according to the detected mark to control a printing operation of the print unit.

18. The image forming apparatus of claim 17, further comprising:
a user interface to allow users to input information regarding currently fed paper.

19. The image forming apparatus of claim 18, wherein an error message may be displayed via the user interface.

20. The image forming apparatus of claim 17, further comprising:
a determination unit to determine whether the paper is fed in a proper direction based upon detection by the detection unit.

21. The image forming apparatus of claim 17, wherein the detection unit detects the multiple marks having different properties and the marks comprise multiple marks formed on multiple locations of the printing medium.

22. The image forming apparatus of claim 17, wherein the printing operation comprises:
flipping and re-feeding the printing medium if no mark is detected.

23. The image forming apparatus of claim 17, wherein the printing operation comprises a feeding direction and the print control unit controls the feeding directions of the printing medium of the print unit.
